(19) United States
(12) Patent Application Publication
(10) Pub. No.: US 2007/0006261 A1
(43) Pub. Date: Jan. 4, 2007

(54) Broadcast receiving set, broadcast receiver device, channel addition control method, and channel deletion control method

(75) Inventor: Keisuke Tsukamoto, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/451,923

(22) Filed: Jun. 13, 2006

(30) Foreign Application Priority Data
Jun. 20, 2005 (JP) 2005-179185

(51) Int. Cl. H04N 5/445

(52) U.S. Cl. 725/39

(57) ABSTRACT

A choice of an EPG map or a channel-selection map is received. An obtainable channel unregistered in the EPG map is extracted from the retrieved EPG obtainable channels. If the EPG map is chosen, a choice of an addition-desired channel is received among the extracted obtainable channels. The received channel is added to the EPG map as an EPG display channel. A receivable channel unregistered in the channel-selection map is extracted from the retrieved broadcast receivable channels. If the channel-selection map is chosen, a choice of an addition-desired channel is received among the extracted receivable channels. The received channel is added to the channel-selection map as a selectable channel. Therefore, it is possible to allow selection of a channel without allowing display of EPG of the channel and to allow display of EPG of a channel without allowing selection of the channel.

### BACKGROUND OF THE INVENTION

1. Field of the Invention

The present invention relates to a broadcast receiving set, a broadcast receiver device, a channel addition control method, and a channel deletion control method. More particularly, the present invention relates to a broadcast receiving set suitable to add or delete a channel, a broadcast receiver device, a channel addition control method, and a channel deletion control method.

2. Description of the Background Art

Conventionally, in a broadcast receiving set such as a television set, information of programs on selectable channels is displayed in EPG (Electronic Program Guide). More specifically, a channel that can be selected and a channel that allows display of EPG are specified by the same channel map.

Therefore, when a new channel is added to a channel map, the new channel is added to the channels that can be selected and also added to the channels that allow display of EPG. On the other hand, when any channel is deleted from the channel map, the deleted channel is deleted from the channels that can be selected and also deleted from the channels that allow display of EPG.

Japanese Patent Laying-Open No. 2004-179716 (referred to as “Patent Document 1” hereinafter) discloses a digital broadcast receiver device storing a channel or a time zone unnecessary for the user in a memory as individual program guide component information and displaying an individual EPG screen set in the individual program guide component information (see, for example, the paragraph 0028 of Patent Document 1).

Japanese Patent Laying-Open No. 2001-197389 (referred to as “Patent Document 2” hereinafter) discloses a digital broadcast receiver including a channel display mechanism, which selects a channel unnecessary for the user from a plurality of channels initially displayed on the screen, and displays the channels other than the selected unnecessary channel in a list on the screen to give a choice to the viewer (see, for example, the paragraph 0010 of Patent Document 2).

Japanese Patent Laying-Open No. 2001-148812 (referred to as “Patent Document 3” hereinafter) discloses an information display device setting a channel index corresponding to each information of a television broadcast, an external input, and the Internet, integrally displaying the prescribed registered channel indexes on the screen of the display device, and determining information to be displayed on the display device using a remote control unit to select the channel indexes integrally displayed (see, for example, the paragraph 0041 of Patent Document 3).

However, in accordance with the conventional techniques, in order to select even a channel that does not allow display of EPG since EPG data is not provided, the channel needs to be registered in the channel map.

Moreover, in accordance with the conventional techniques, in order to display even a channel usually not selected but having EPG desired to be checked, the channel needs to be registered in the channel map.

Furthermore, the digital broadcast receiver device disclosed in Patent Document 1, the digital broadcast receiver disclosed in Patent Document 2, and the information display device disclosed in Patent Document 3 do not allow only selection of the channel without allowing display of EPG of the channel, or only display of EPG of the channel without allowing selection of the channel.

### SUMMARY OF THE INVENTION

The present invention is made to solve the aforementioned problem. An object of the present invention is to provide a broadcast receiving set allowing selection of a channel without allowing display of the electronic program guide of the channel and allowing display of an electronic program guide of a channel without allowing selection of the channel, a broadcast receiver device, a channel addition control method, and a channel deletion control method.

In order to solve the above-noted problem, in accordance with an aspect of the present invention, a broadcast receiver device includes an electronic program guide channel map storing unit, a channel-selection channel map storing unit, a choice reception unit, an obtainable channel extraction unit, an obtainable channel reception unit, an obtainable channel addition unit, a receivable channel extraction unit, a receivable channel reception unit, and a receivable channel addition unit.

The electronic program guide channel map storing unit stores an electronic program guide channel map that can specify an electronic program guide display channel allowing display of an electronic program guide. The channel-selection channel map storing unit stores a channel-selection channel map that can specify a selectable channel that can be selected. The choice reception unit receives from a user a choice of either the electronic program guide channel map stored in the electronic program guide channel map storing unit or the channel-selection channel map stored in the channel-selection channel map storing unit, as a channel map to which a channel is to be added.

The obtainable channel extraction unit searches for an obtainable channel for which the electronic program guide can be obtained, to extract the obtainable channel that cannot be specified as an electronic program guide display channel in the electronic program guide channel map stored in the electronic program guide channel map storing unit, from the retrieved obtainable channel. The obtainable channel reception unit receives a choice of the obtainable channel desired by a user to be added to the electronic program guide channel map from the obtainable channel extracted by the obtainable channel extraction unit, when a choice of the electronic program guide channel map is received by the choice reception unit. The obtainable channel addition unit adds the obtainable channel received by the obtainable channel reception unit to the electronic program guide channel map stored in the electronic program guide channel map storing unit such that the obtainable channel can be specified as the electronic program guide display channel.

The receivable channel extraction unit searches for a receivable channel on which a broadcast can be received, to extract the receivable channel that cannot be specified as the selectable channel in the channel-selection channel map stored in the channel-selection channel map storing unit, from the retrieved receivable channel. The receivable channel reception unit receives a choice of the receivable channel desired by a user to be added to the channel-selection channel map from the receivable channel extracted by the receivable channel extraction unit, when a choice of the channel-selection channel map is received by the choice reception unit. The receivable channel addition unit adds the receivable channel received by the receivable channel reception unit to the channel-selection channel map stored in the channel-selection channel map storing unit such that the receivable channel can be specified as the selectable channel.

In the broadcast receiver device in accordance with the present invention, an electronic program guide channel map that can specify an electronic program guide display channel allowing display of an electronic program guide is stored. A channel-selection channel map that can specify a selectable channel that can be selected is stored. A choice of either the electronic program guide channel map or the channel-selection channel map is received from the user as a channel map to which a channel is to be added.

In addition, in the broadcast receiver device, an obtainable channel for which electronic program guide can be obtained is searched for, and an obtainable channel that cannot be specified as an electronic program guide display channel in the electronic program guide channel map is extracted from the retrieved obtainable channels. When the choice of the electronic program guide channel map is received, a choice of an obtainable channel desired by the user to be added to the electronic program guide channel map is received from the extracted obtainable channels. The received obtainable channel is added to the electronic program guide channel map such that it can be specified as an electronic program guide display channel.

Furthermore, in the broadcast receiver device, a receivable channel on which a broadcast can be received is searched for, and a receivable channel that cannot be specified as a selectable channel in the channel-selection channel map is extracted from the retrieved receivable channels. When the choice of the channel-selection channel map is received, a choice of a receivable channel desired by the user to be added to the channel-selection channel map is received from the extracted receivable channels. The received receivable channel is added to the channel-selection channel map such that it can be specified as a selectable channel.

Therefore, in the broadcast receiver device, a channel that allows display of an electronic program guide and a channel that can be selected are stored in the electronic program guide channel map and the channel-selection channel map, respectively. An obtainable channel and a receivable channel desired by the user to be added are added to the electronic program guide channel map and the channel-selection channel map, respectively. As a result, it is possible to provide a broadcast receiver device allowing selection of a channel without allowing display of the electronic program guide of the channel and allowing display of an electronic program guide of a channel without allowing selection of the channel.

Preferably, the broadcast receiver device further includes: an obtainable channel display signal output unit outputting a signal to display obtainable channel information indicating the obtainable channel extracted by the obtainable channel extraction unit; and a receivable channel display signal output unit outputting a signal to display receivable channel information indicating the receivable channel extracted by the receivable channel extraction unit.

The obtainable channel reception unit receives a choice of the obtainable channel desired by a user to be added, from the obtainable channel indicated by the obtainable channel information displayed in response to the signal output by the obtainable channel display signal output unit. The receivable channel reception unit receives a choice of the receivable channel desired by a user to be added, from the receivable channel indicated by the receivable channel information displayed in response to the signal output by the receivable channel display signal output unit.

In the broadcast receiver device in accordance with the present invention, a signal is output to display obtainable channel information indicating the extracted obtainable channel, and a signal is output to display receivable channel information indicating the extracted receivable channel. A choice of an obtainable channel desired by the user to be added is received from the obtainable channels indicated by the obtainable channel information displayed in response to the output signal. A choice of a receivable channel desired by the user to be added is received from the receivable channel indicated by the receivable channel information displayed in response to the output signal.

Therefore, the user can readily know the obtainable channel and the receivable channel which may be desired to be added by the user.

Preferably, the electronic program guide channel map storing unit and the channel-selection channel map storing unit store, in association with channel identification information that can specify a channel, the electronic program guide channel map that can specify that an electronic program guide of a channel that can be specified by the channel identification information is displayed and the channel-selection channel map that can specify that a channel that can be specified by the channel identification information can be selected, as one channel map.

In the broadcast receiver device in accordance with the present invention, in association with channel identification information that can specify a channel, the electronic program guide channel map that can specify that an electronic program guide of a channel that can be specified by the channel identification information is displayed, and the channel-selection channel map that can specify that a channel that can be specified by the channel identification information can be selected, are stored as one channel map.

Therefore, the channel identification information does not have to be redundantly stored both in the electronic program guide channel map and in the channel-selection channel map. As a result, a storage capacity for storing a channel map can be reduced.

In accordance with another aspect of the present invention, a broadcast receiver device includes an electronic program guide channel map storing unit, a channel-selection channel map storing unit, a choice reception unit, an electronic program guide already-registered channel reception unit, an electronic program guide already-registered channel deletion unit, a channel-selection already-registered channel reception unit, and a channel-selection already-registered channel deletion unit.

The electronic program guide channel map storing unit stores an electronic program guide channel map that can specify an electronic program guide display channel allowing display of an electronic program guide. The channel-selection channel map storing unit stores a channel-selection channel map that can specify a selectable channel that can be selected. The choice reception unit receives from a user a choice of either the electronic program guide channel map stored in the electronic program guide channel map storing unit or the channel-selection channel map stored in the channel-selection channel map storing unit, as a channel map from which a channel is to be deleted.

The electronic program guide already-registered channel reception unit receives a choice of an already-registered channel for electronic program guide desired by a user to be deleted from the electronic program guide channel map from the already-registered channel for electronic program guide that can be specified as an electronic program guide display channel in the electronic program guide channel map stored in the electronic program guide channel map storing unit, when a choice of the electronic program guide channel map is received by the choice reception unit. The electronic program guide already-registered channel deletion unit deletes the already-registered channel for electronic program guide received by the electronic program guide already-registered channel reception unit from the electronic program guide channel map stored in the electronic program guide channel map storing unit such that the already-registered channel for electronic program guide cannot be specified as the electronic program guide display channel.

The channel-selection already-registered channel reception unit receives a choice of an already-registered channel for channel-selection desired by a user to be deleted from the channel-selection channel map from the already-registered channel for channel-selection that can be specified as a selectable channel in the channel-selection channel map stored in the channel-selection channel map storing unit, when a choice of the channel-selection channel map is received by the choice reception unit. The channel-selection already-registered channel deletion unit deletes the already-registered channel for channel-selection received by the channel-selection already-registered channel reception unit from the channel-selection channel map stored in the channel-selection channel map storing unit such that the already-registered channel for channel-selection cannot be specified as the selectable channel.

In the broadcast receiver device in accordance with the present invention, an electronic program guide channel map that can specify an electronic program guide display channel allowing display of an electronic program guide is stored, and a channel-selection channel map that can specify a selectable channel that can be selected is stored. A choice of either the electronic program guide channel map or the channel-selection channel map is received from the user as a channel map from which a channel is to be deleted.

Furthermore, when the choice of the electronic program guide channel map is received, a choice of an already-registered channel for electronic program guide desired by the user to be deleted from the electronic program guide channel map is received from the already-registered channels for electronic program guide that can be specified as electronic program guide display channels in the electronic program guide channel map. The received already-registered channel for electronic program guide is deleted from the electronic program guide channel map such that it cannot be specified as an electronic program guide display channel.

On the other hand, when the choice of the channel-selection channel map is received, a choice of an already-registered channel for channel-selection desired by the user to be deleted from the channel-selection channel map is received from the already-registered channels for channel-selection that can be specified as selectable channels in the channel-selection channel map. The received already-registered channel for channel-selection is deleted from the channel-selection channel map such that it cannot be specified as a selectable channel.

Therefore, in the broadcast receiver device, a channel that allows display of an electronic program guide and a channel that can be selected are stored in the electronic program guide channel map and the channel-selection channel map, respectively. The already-registered channel for electronic program guide and the already-registered channel for channel-selection desired by the user to be deleted are deleted from the electronic program guide channel map and the channel-selection channel map, respectively. As a result, it is possible to provide a broadcast receiver device allowing selection of a channel without allowing display of the electronic program guide of the channel and allowing display of an electronic program guide of a channel without allowing selection of the channel.

Preferably, the broadcast receiver device further includes: an electronic program guide already-registered channel display signal output unit outputting a signal to display electronic program guide already-registered channel information indicating the already-registered channel for electronic program guide that can be specified in the electronic program guide channel map stored in the electronic program guide channel map storing unit; and a channel-selection already-registered channel display signal output unit outputting a signal to display channel-selection already-registered channel information indicating the already-registered channel for channel-selection that can be specified in the channel-selection channel map stored in the channel-selection channel map storing unit.

The electronic program guide already-registered channel reception unit receives a choice of the already-registered channel for electronic program guide desired by a user to be deleted from the already-registered channel for electronic program guide indicated by the electronic program guide already-registered channel information displayed in response to the signal output by the electronic program guide already-registered channel display signal output unit. The channel-selection already-registered channel reception unit receives a choice of the already-registered channel for channel-selection desired by a user to be deleted from the already-registered channel for channel-selection indicated by the channel-selection already-registered channel information displayed in response to the signal output by the channel-selection already-registered channel display signal output unit.

In the broadcast receiver device in accordance with the present invention, a signal is output to display electronic program guide already-registered channel information indicating an already-registered channel for electronic program guide that can be specified in the electronic program guide channel map. A signal is output to display channel-selection already-registered channel information indicating an already-registered channel for channel-selection that can be specified in the channel-selection channel map. A choice of an already-registered channel for electronic program guide desired by the user to be deleted is received from the already-registered channels for electronic program guide indicated by the electronic program guide already-registered channel information displayed in response to the output signal. A choice of an already-registered channel for channel-selection desired by the user to be deleted is received from the already-registered channels for channel-selection indicated by the channel-selection already-registered channel information displayed in response to the output signal.

Therefore, the user can readily know the already-registered channel for electronic program guide and the already-registered channel for channel-selection, which may be desired to be deleted by the user.

Preferably, the electronic program guide channel map storing unit and the channel-selection channel map storing unit store, in association with channel identification information that can specify a channel, the electronic program guide channel map that can specify that an electronic program guide of a channel that can be specified by the channel identification information is displayed, and the channel-selection channel map that can specify that a channel that can be specified by the channel identification information can be selected, as one channel map.

In the broadcast receiver device in accordance with the present invention, in association with channel identification information that can specify a channel, the electronic program guide channel map that can specify that an electronic program guide of a channel that can be specified by the channel identification information is displayed, and the channel-selection channel map that can specify that a channel that can be specified by the channel identification information can be selected, are stored as one channel map.

Therefore, the channel identification information does not have to be redundantly stored both in the electronic program guide channel map and in the channel-selection channel map. As a result, a storage capacity for storing a channel map can be reduced.

In accordance with a further aspect of the present invention, a broadcast receiving set includes the broadcast receiver device as described above and a display unit displaying information indicated by a signal output from the broadcast receiver device.

In accordance with the present invention, the broadcast receiving set displays obtainable channel information, receivable channel information, electronic program guide already-registered channel information, or channel-selection already-registered channel information, each indicated by a signal output from the broadcast receiver device.

Therefore, in the broadcast receiving set, a channel that allows display of an electronic program guide and a channel that can be selected are stored in the electronic program guide channel map and the channel-selection channel map, respectively. The obtainable channel and the receivable channel desired to be added by the user are added to the electronic program guide channel map and the channel-selection channel map, respectively. As a result, it is possible to provide a broadcast receiving set allowing selection of a channel without allowing display of the electronic program guide of the channel and allowing display of an electronic program guide of a channel without allowing selection of the channel.

Furthermore, in the broadcast receiving set, a channel that allows display of an electronic program guide and a channel that can be selected are stored in the electronic program guide channel map and the channel-selection channel map, respectively. The already-registered channel for electronic program guide and the already-registered channel for channel-selection desired to be deleted by the user are deleted from the electronic program guide channel map and the channel-selection channel map, respectively. As a result, it is possible to provide a broadcast receiving set allowing selection of a channel without allowing display of the electronic program guide of the channel and allowing display of an electronic program guide of a channel without allowing selection of the channel.

In accordance with yet another aspect of the present invention, a channel addition control method is performed by a broadcast receiver device including a storage unit for storing prescribed information. The storage unit stores an electronic program guide channel map that can specify an electronic program guide display channel allowing display of an electronic program guide and a channel-selection channel map that can specify a selectable channel that can be selected.

The channel addition control method includes the steps of receiving from a user a choice of either the electronic program guide channel map or the channel-selection channel map stored in the storage unit, as a channel map to which a channel is to be added; searching for an obtainable channel for which the electronic program guide can be obtained, to extract the obtainable channel that cannot be specified as an electronic program guide display channel in the electronic program guide channel map stored in the storage unit, from the retrieved obtainable channel; receiving a choice of the obtainable channel desired by a user to be added to the electronic program guide channel map from the extracted obtainable channel, when a choice of the electronic program guide channel map is received; adding the received obtainable channel to the electronic program guide channel map stored in the storage unit such that the obtainable channel can be specified as the electronic program guide display channel; searching for a receivable channel on which a broadcast can be received, to extract the receivable channel that cannot be specified as the selectable channel in the channel-selection channel map stored in the storage unit, from the retrieved receivable channel; receiving a choice of the receivable channel desired by a user to be added to the channel-selection channel map from the extracted receivable channel, when a choice of the channel-selection channel map is received; and adding the received receivable channel to the channel-selection channel map stored in the storage unit such that the receivable channel can be specified as the selectable channel.

In the channel addition control method in accordance with the present invention, a choice of either the electronic program guide channel map or the channel-selection channel map is received from the user as a channel map to which a channel is to be added. An obtainable channel for which the electronic program guide can be obtained is searched for, and the obtainable channel that cannot be specified as an electronic program guide display channel in the electronic program guide channel map is extracted from the retrieved obtainable channels. When the choice of the electronic program guide channel map is received, a choice of the obtainable channel desired by a user to be added to the electronic program guide channel map is received from the extracted obtainable channels. The received obtainable channel is added to the electronic program guide channel map such that it can be specified as an electronic program guide display channel. A receivable channel on which a broadcast can be received is searched for, and the receivable channel that cannot be specified as the selectable channel in the channel-selection channel map is extracted from the retrieved receivable channels. When the choice of the channel-selection channel map is received, a choice of the receivable channel desired by a user to be added to the channel-selection channel map is received from the extracted receivable channels. The received receivable channel is added to the channel-selection channel map such that it can be specified as a selectable channel.

Therefore, in the channel addition control method, a channel that allows display of an electronic program guide and a channel that can be selected are stored in the electronic program guide channel map and the channel-selection channel map, respectively. The obtainable channel and the receivable channel desired to be added by the user are added to the electronic program guide channel map and the channel-selection channel map, respectively. As a result, it is possible to provide a channel addition control method allowing selection of a channel without allowing display of the electronic program guide of the channel and allowing display of an electronic program guide of a channel without allowing selection of the channel.

In accordance with a still further aspect of the present invention, a channel deletion control method is performed by a broadcast receiver device including a storage unit storing prescribed information. The storage unit stores an electronic program guide channel map that can specify an electronic program guide display channel allowing display of an electronic program guide and a channel-selection channel map that can specify a selectable channel that can be selected.

The channel deletion control method includes the steps of receiving from a user a choice of either the electronic program guide channel map or the channel-selection channel map stored in the storage unit, as a channel map from which a channel is to be deleted; receiving a choice of an already-registered channel for electronic program guide desired by a user to be deleted from the electronic program guide channel map from the already-registered channel for electronic program guide that can be specified as an electronic program guide display channel in the electronic program guide channel map stored in the storage unit, when a choice of the electronic program guide channel map is received; deleting the received already-registered channel for electronic program guide from the electronic program guide channel map stored in the storage unit such that the already-registered channel for electronic program guide cannot be specified as the electronic program guide display channel; receiving a choice of an already-registered channel for channel-selection desired by a user to be deleted from the channel-selection channel map from the already-registered channel for channel-selection that can be specified as a selectable channel in the channel-selection channel map stored in the storage unit, when a choice of the channel-selection channel map is received; and deleting the received already-registered channel for channel-selection from the channel-selection channel map stored in the storage unit such that the already-registered channel for channel-selection cannot be specified as the selectable channel.

In the channel deletion control method in accordance with the present invention, a choice of either the electronic program guide channel map or the channel-selection channel map is received from the user as a channel map from which a channel is to be deleted. When the choice of the electronic program guide channel map is received, a choice of an already-registered channel for electronic program guide desired by a user to be deleted from the electronic program guide channel map is received from the already-registered channels for electronic program guide that can be specified as electronic program guide display channels in the electronic program guide channel map stored in the storage unit. The received already-registered channel for electronic program guide is deleted from the electronic program guide channel map such that it cannot be specified as an electronic program guide display channel. When the choice of the channel-selection channel map is received, a choice of the already-registered channel for channel-selection desired by a user to be deleted from the channel-selection channel map is received from the already-registered channels for channel-selection that can be specified as selectable channels in the channel-selection channel map. The received already-registered channel for channel-selection is deleted from the channel-selection channel map such that it cannot be specified as the selectable channel.

Therefore, in the channel deletion control method, a channel that allows display of an electronic program guide and a channel that can be selected are stored in the electronic program guide channel map and the channel-selection channel map, respectively. The already-registered channel for electronic program guide and the already-registered channel for channel-selection desired by the user to be deleted are deleted from the electronic program guide channel map and the channel-selection channel map, respectively. As a result, it is possible to provide a channel deletion control method allowing selection of a channel without allowing display of the electronic program guide of the channel and allowing display of an electronic program guide of a channel without allowing selection of the channel.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram of a broadcast receiving set in accordance with an embodiment of the present invention.

FIG. 2 is a flowchart illustrating a flow of a channel addition process performed in the broadcast receiving set in accordance with the embodiment of the present invention.

FIG. 3 is a display screen view showing an exemplary channel addition menu screen output in the broadcast receiving set in accordance with the embodiment of the present invention.

FIG. 4 is a display screen view showing an exemplary channel-selection channel map channel addition screen output in the broadcast receiving set in accordance with the embodiment of the present invention.

FIG. 5 is a display screen view showing an exemplary EPG channel map channel addition screen output in the broadcast receiving set in accordance with the embodiment of the present invention.

FIG. 6 is a display screen view showing an exemplary EPG screen output in the broadcast receiving set in accordance with the embodiment of the present invention.

FIG. 7 is a second display screen view showing an exemplary EPG screen output in the broadcast receiving set in accordance with the embodiment of the present invention.

FIG. 8 is a flowchart illustrating a flow of a channel deletion process performed in the broadcast receiving set in accordance with the embodiment of the present invention.

FIG. 9 is a display screen view showing an exemplary channel deletion menu screen output in the broadcast receiving set in accordance with the embodiment of the present invention.

FIG. 10 is a display screen view showing an exemplary channel-selection channel map channel deletion screen output in the broadcast receiving set in accordance with the embodiment of the present invention.

FIG. 11 is a display screen view showing an exemplary EPG channel map channel deletion screen output in the broadcast receiving set in accordance with the embodiment of the present invention.

### DESCRIPTION OF THE PREFERRED EMBODIMENTS

In the following, an embodiment of the present invention will be described in detail with reference to the figures. It is noted that in the figures the same or corresponding parts will be denoted with the same reference characters and the description thereof will not be repeated.

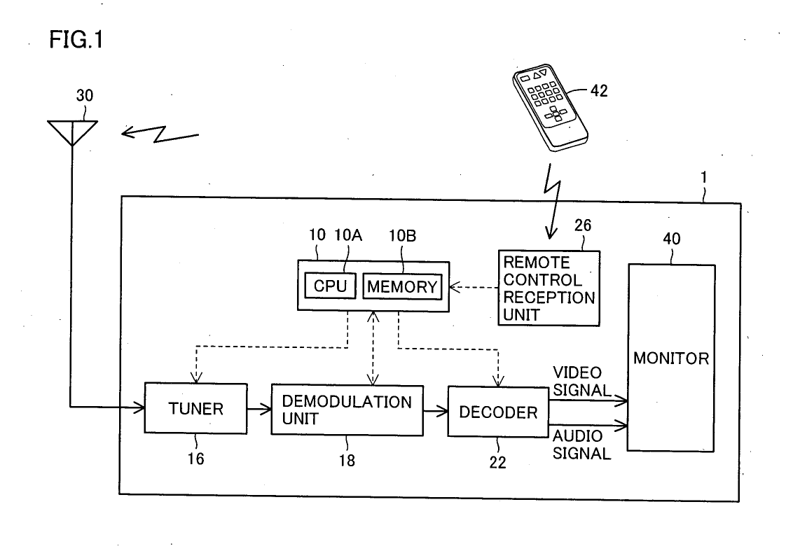

Referring to FIG. 1, a broadcast receiving set 1 in accordance with an embodiment of the present invention receives a broadcast signal from an antenna 30, receives an instruction signal from a remote control 42, and outputs a video signal and an audio signal to a monitor 40.

Antenna 30 receives a broadcast signal transmitted via radio waves from a broadcast station to supply the received broadcast signal to broadcast receiving set 1.

Remote control 42 receives a desired operation from the user to transmit an operation signal according to the user's operation to broadcast receiving set 1 by infrared radiation. It is noted that an operation signal output from remote control 42 is not limited to infrared and may be radio waves. Furthermore, in place of remote control 42 and a remote control reception unit 26, or in addition to remote control 42 and remote control reception unit 26, the main unit of broadcast receiving set 1 may be provided with an operation receiving unit receiving an operation from the user to output an operation signal to a control unit 10.

Broadcast receiving set 1 includes a control unit 10, a tuner 16, a demodulation unit 18, a decoder 22, a remote control reception unit 26, and a monitor 40.

Control unit 10 includes a CPU (Central Processing Unit) 10A executing a program and a memory 10B storing the executed program, data in the course of execution of the program, and data resulting from execution of the program.

Tuner 16 extracts a broadcast signal corresponding to a channel selected in response to an instruction from control unit 10 from the received broadcast signals. Then, tuner 16 outputs the extracted broadcast signal to demodulation unit 18.

Demodulation unit 18 is controlled by control unit 10 to receive the broadcast signal from tuner 16, demodulate the broadcast signal to MPEG-2TS (Moving Picture Experts Group phase 2 Transport Stream) signal, which is digitally-coded video and audio signals, and output the MPEG-2TS signal to decoder 22.

Here, a digital television broadcast signal is coded in Read-Solomon Code and Convolutional Code for transmission. Therefore, demodulation unit 18 can correct an error in the aforementioned demodulation process. In the course of the error correction processing, demodulation unit 18 calculates a received data error rate of the received broadcast signal and outputs the received data error rate to control unit 10.

It is noted that the digital television broadcasting includes ISDB-T (Integrated Services Digital Broadcasting for Terrestrial) system in Japan and, in addition, ATSC (Advanced Television Systems Committee) system In the United States and DVB-T (Digital Video Broadcasting for Terrestrial) system In Europe.

Decoder 22 is controlled by control unit 10 to decode the MPEG-2TS signal received from demodulation unit 18 to a video signal and an audio signal. Then, decoder 22 outputs the decoded video signal and audio signal to monitor 40.

Monitor 40 converts the video signal and the audio signal from decoder 22 to video and audio, respectively, so that the user can enjoy the converted video and audio.

Remote control reception unit 26 receives an operation signal from remote control 42 and outputs the received operation signal to control unit 10.

Control unit 10 controls tuner 16, demodulation unit 18, and decoder 22 according to the operation signal received from remote control reception unit 26.

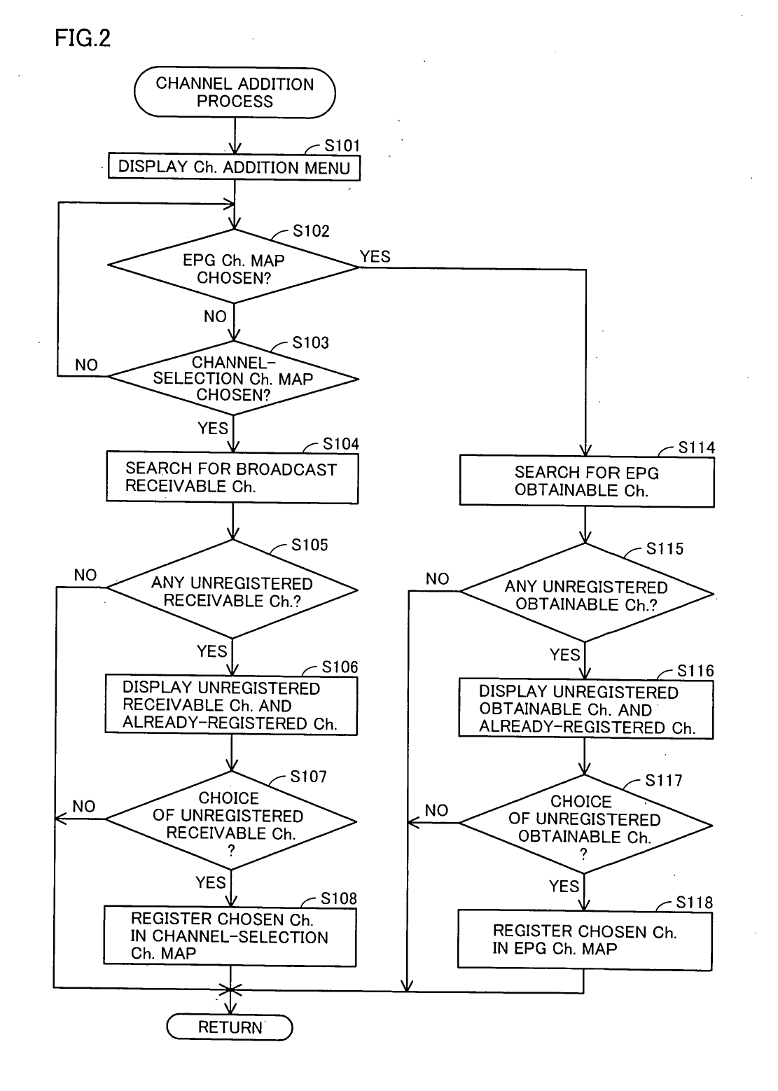

Referring to FIG. 2, the channel addition process is performed when an instruction to add a channel is received from the user. First, at step S101, control unit 10 causes monitor 40 to display a channel addition menu screen.

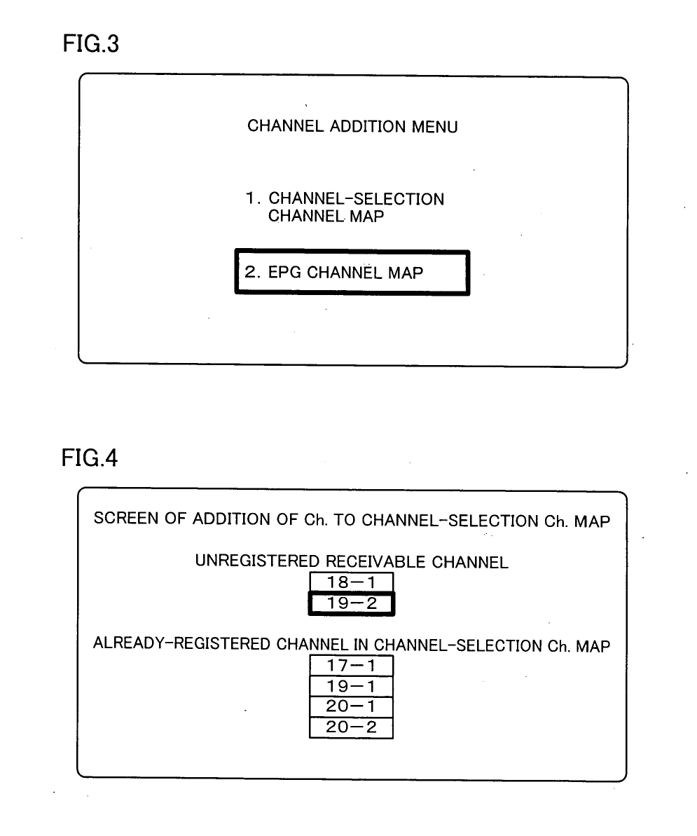

Referring to FIG. 3, the channel addition menu screen includes characters “channel addition menu” that is the designation of the screen, and characters “1. channel-selection channel map” and “2. EPG channel map”, which are choices to be selected as a channel map to which a channel is added.

Here, the characters “2. EPG channel map” are displayed in such a manner that they are enclosed by a bold line to indicate that they are possibly chosen. Using remote control 42, the user can perform a switching operation to choose between those channel maps. In addition, using remote control 42, the user can perform an operation to decide the chosen channel map as a channel map to which a channel is to be added.

TABLE 1

| | Registered Channel for | Registered Channel for |
|---|---|---|
| Ch. No. | Channel-Selection | EPG |
| 17-1 | already-registered | already-registered |
| 19-1 | already-registered | already-registered |
| 20-1 | already-registered | already-registered |
| 20-2 | already-registered | already-registered |
| 21-1 | unregistered | unregistered |
| 22-1 | unregistered | unregistered |

Table 1 is a first table showing a channel map including a channel-selection channel map for use to select a channel and an EPG channel map for use with EPG.

Referring to Table 1, this channel map is stored in memory 10B of control unit 10. This channel map includes a channel-selection channel map formed of a channel number field and a channel-selection registered channel field, and an EPG channel map formed of a channel number field and an EPG registered channel field.

The channel-selection channel map shows that the channels each represented by “17-1”, “19-1”, “20-1”, “20-2” have already been registered in the channel-selection channel map, and the channels each represented by “21-1”, “22-1” were registered before in the channel-selection channel map or the EPG channel map but are not presently registered in the channel-selection channel map.

Similarly, the EPG channel map shows that the channels each represented by “17-1”, “19-1”, “20-1”, “20-2” have already been registered in the EPG channel map, and the channels each represented by “21-1”, “22-1” were registered before in the channel-selection channel map or the EPG channel map but are not presently registered in the EPG channel map.

Returning to FIG. 2, at step S102, control unit 10 determines whether or not a signal to decide the choice of the EPG channel map is received from remote control reception unit 26. If it is determined that a signal to decide the choice of the EPG channel map is received (if YES at step S102), control unit 10 advances the process to be performed to step S114.

On the other hand, if it is determined that a signal to decide the choice of the EPG channel map is not received (if NO at step S102), at step S103, control unit 10 determines whether or not a signal to decide the choice of the channel-selection channel map is received from remote control reception unit 26. If it is determined that a signal to decide the choice of the channel-selection channel map is not received (if NO at step S103), control unit 10 returns the process to be performed to step S102.

On the other hand, if it is determined that a signal to decide the choice of the channel-selection channel map is received (if YES at step S103), at step S104, control unit 10 controls tuner 16 to search for a channel on which a broadcast can be received. Then, at step S105, control unit 10 determines whether or not there exists a channel on which a broadcast can be received and which is not registered in the channel-selection channel map, based on the search result at step S104 and the channel-selection channel map stored in memory 10B. If it is determined that there is no unregistered receivable channel (if NO at step S105), control unit 10 returns the process to be performed to the caller process of this channel addition process.

On the other hand, if it is determined that there is an unregistered receivable channel (if YES at step S105), at step S106, control unit 10 causes monitor 40 to display information indicating the unregistered receivable channel as determined at step S105 and information indicating a channel that has already been registered in the channel-selection channel map stored in memory 10B.

Referring to FIG. 4, the screen of addition of channel to channel-selection channel map includes: characters “screen of addition of Ch. to channel-selection Ch. Map” that is the designation of this screen; characters “unregistered receivable channel” that is the designation of the list of the unregistered receivable channels; numerals “18-1”, “19-2” in the list showing the unregistered receivable channels; characters “already-registered channel in channel-selection Ch. Map” that is the designation of the list of the already-registered channels in the channel-selection channel map; and numerals “17-1”, “19-1”, “20-1”, “20-2” in the list showing the already-registered channels.

Here, the channel represented by the numerals “19-2” is displayed in such a manner that it is enclosed by a bold line to indicate that it is possibly chosen as a channel to be added to the channel-selection channel map. Using remote control 42, the user can perform a switching operation to choose between these unregistered receivable channels. In addition, using remote control 42, the user can perform an operation to decide the chosen, unregistered receivable channel as a channel added to the channel-selection channel map.

Returning to FIG. 2, at step S107, control unit 10 determines whether or not a signal to decide a choice of any of the unregistered receivable channels is received from remote control reception unit 26. If it is determined that a signal to decide a choice of any of the unregistered receivable channels is not received (if NO at step S107), control unit 10 returns the process to be performed to the caller process of this channel addition process.

On the other hand, if it is determined that a signal to decide a choice of any of the unregistered receivable channels is received (if YES at step S107), at step S108, control unit 10 additionally registers the decided, unregistered receivable channel in the channel-selection channel map stored in memory 10B. Thereafter, control unit 10 returns the process to be performed to the caller process of this channel addition process.

Alternatively, if the process proceeds to step S114 at step S102, control unit 10 controls tuner 16 and demodulation unit 18 to search for the channel for which EPG can be obtained. Then, at step S115, control unit 10 determines whether or not there exists a channel for which EPG can be obtained and which is not registered in the EPG channel map, based on the search result at step S114 and the EPG channel map stored in memory 10B. If it is determined that there is no unregistered obtainable channel (if NO at step S115), control unit 10 returns the process to be performed to the caller process of this channel addition process.

On the other hand, if it is determined that there is an unregistered obtainable channel (if YES at step S115), at step S116, control unit 10 causes monitor 40 to display information indicating the unregistered obtainable channel as determined at step S115 and information indicating the channel that has already been registered in the EPG channel map stored in memory 10B.

Referring to FIG. 5, the screen of addition of channel to EPG channel map includes: characters “screen of addition of Ch. to EPG Ch. Map” that is the designation of this screen; characters “unregistered EPG obtainable channel” that is the designation of the list of the unregistered obtainable channels; numerals and characters “18-1 Baseball” “19-2 Documentary” in the list including information indicating the unregistered obtainable channels and information indicating the types of the programs shown in EPG on those channels for a prescribed time (here, two hours) from the present time; characters “already-registered channel in EPG Ch. Map” that is the designation of the list of the already-registered channels in the EPG channel map; and numerals and characters “17-1 Drama”, “19-1 News”, “20-1 Cinema”, “20-1 Animation” in the list including information indicating the already-registered channels and information indicating the types of the programs shown in EPG on those channels for a prescribed time (here, two hours) from the present time.

Here, the channel represented by numerals and characters “18-1 Baseball” is displayed in such a manner that it is enclosed by a bold line to indicate that it is possibly chosen as a channel to be added to the EPG channel map. Using remote control 42, the user can perform a switching operation to choose between these unregistered obtainable channels. In addition, using remote control 42, the user can perform an operation to decide the chosen, unregistered obtainable channel as a channel to be added to the EPG channel map.

Returning to FIG. 2, at step S117, control unit 10 determines whether or not a signal to decide a choice of any of the unregistered obtainable channels is received from remote control reception unit 26. If it is determined that a signal to decide a choice of any of the unregistered obtainable channels is not received (if NO at step S117), control unit 10 returns the process to be performed to the caller process of this channel addition process.

On the other hand, if it is determined that a signal to decide a choice of any of the unregistered obtainable channels is received (if YES at step S117), at step S118, control unit 10 additionally registers the decided, unregistered obtainable channel in the EPG channel map stored in memory 10B. Thereafter, CPU 10 returns the process to be performed to the caller process of this channel addition process.

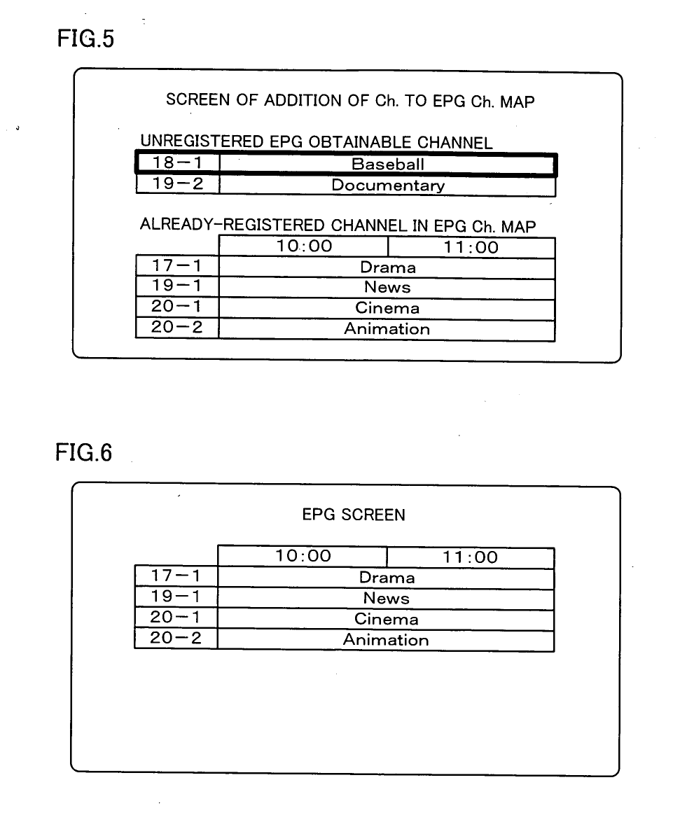

Referring to FIG. 6, the EPG screen includes: characters “EPG screen” that is the designation of this screen; numerals “10:00”, “11:00” which are information indicating a time zone for a prescribed time from the present time; and a list including information indicating the already-registered channels in the EPG channel map and information indicating the types of the programs shown in EPG on those channels for a prescribed time (here, two hours) from the present time. Displayed in this list are numerals and characters “17-1 Drama”, “19-1 News”, “20-1 Cinema”, “20-2 Animation”. It is noted that although here, the information indicating the types of the programs is displayed, other information included in EPG may be displayed.

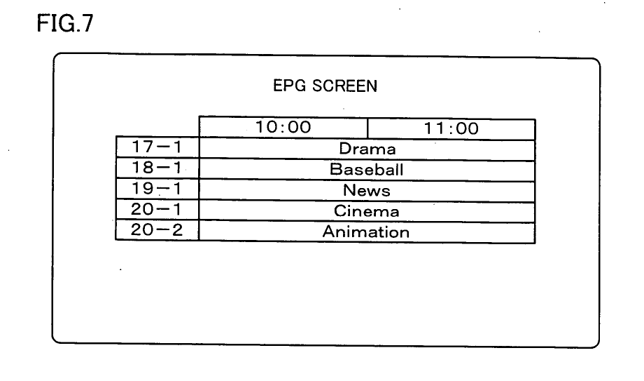

Referring to FIG. 7, this EPG screen appears when the channel addition process shown in FIG. 2 is performed so that the EPG obtainable channel desired by the user is added to the EPG channel map where the EPG screen in FIG. 6 is displayed.

The EPG screen in FIG. 7 includes: characters “EPG screen” that is the designation of this screen; numerals “10:00” “11:00” which are information indicating the time zone for a prescribed tine from the present time; and a list including information indicating the already-registered channels in the EPG channel map including the added channel and information indicating the types of the programs shown in EPG on those channels for a prescribed time from the present time. In this list, in addition to those in the list of the EPG screen in FIG. 6, numerals and characters “18-1 Baseball” are displayed.

TABLE 2

| | Registered Channel for | Registered Channel for |
|---|---|---|
| Ch. No. | Channel-Selection | EPG |
| 17-1 | already-registered | already-registered |
| 18-1 | unregistered | already-registered |
| 19-1 | already-registered | already-registered |
| 19-2 | already-registered | unregistered |
| 20-1 | already-registered | already-registered |
| 20-2 | already-registered | already-registered |
| 21-1 | unregistered | unregistered |
| 22-1 | unregistered | unregistered |

Table 2 is a second table showing a channel map including a channel-selection channel map and an EPG channel map.

Referring to Table 2, this table is created when the channel addition process illustrated in FIG. 2 is performed so that the receivable channel and the EPG obtainable channel desired by the user are added to the channel-selection channel map and the EPG channel map shown in Table 1.

This channel-selection channel map shows that the channel represented by “19-2” is a channel newly added as an already-registered channel to the already-registered channels shown in the channel-selection channel map in Table 1. Furthermore, it is also shown that the channel represented by “19-2” is not registered in the EPG channel map.

In addition, this EPG channel map shows that the channel represented by “18-1” is a channel newly added as an already-registered channel to the already-registered channels shown in the EPG channel map in Table 1. It is also shown that the channel represented by “18-1” is not registered in the channel-selection channel map.

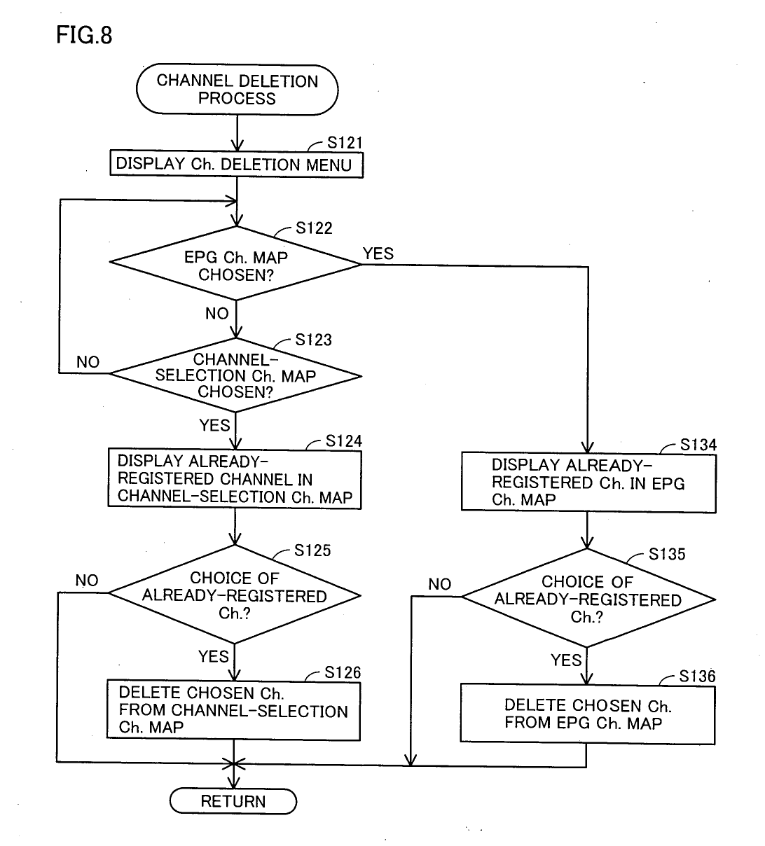

Referring to FIG. 8, this channel deletion process is performed when an instruction to delete a channel is received from the user. First, at step S121, control unit 10 causes monitor 40 to display a channel deletion menu screen.

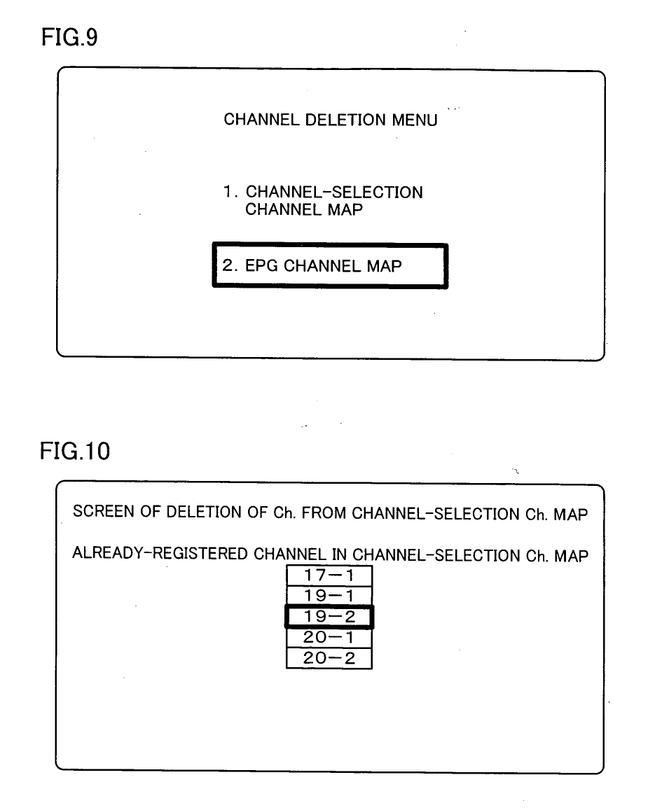

Referring to FIG. 9, the channel deletion menu screen includes: characters “channel deletion menu” that is the designation of this screen; and characters “1. channel-selection channel map” and “2. EPG channel map”, which are choices to be selected as a channel map from which a channel is to be deleted.

Here, the characters “2. EPG channel map” are displayed in such a manner that they are enclosed by a bold line to indicate that they are possibly chosen. Using remote control 42, the user can perform a switching operation to choose between these channel maps. In addition, using remote control 42, the user can perform an operation to decide the chosen channel map as a channel map from which a channel is to be deleted.

Returning to FIG. 8, at step S122, control unit 10 determines whether or not a signal to decide the choice of the EPG channel map is received from remote control reception unit 26. If it is determined that a signal to decide the choice of the EPG channel map is received (if YES at step S122), control unit 10 advances the process to be performed to step S134.

On the other hand, if it is determined that a signal to decide the choice of the EPG channel map is not received (if NO at step S122), at step S123, control unit 10 determines whether or not a signal to decide the choice of the channel-selection channel map is received from remote control reception unit 26. If it is determined that a signal to decide the choice of the channel-selection channel map is not received (if NO at step S123), control unit 10 returns the process to be performed to step S122.

On the other hand, if it is determined that a signal to decide the choice of the channel-selection channel map is received (if YES at step S123), at step S124, control unit 10 causes monitor 40 to display information indicating the channel that has already been registered in the channel-selection channel map stored in memory 10B.

Referring to FIG. 10, the screen of deletion of channel from channel-selection channel map includes: characters “screen of deletion of Ch. from channel-selection Ch. Map” that is the designation of this screen; characters “already-registered channel in channel-selection Ch. Map” that is the designation of the list of the channels already registered in the channel-selection channel map; and numerals “17-1”, “19-1”, “19-2”, “20-1”, “20-2” in the list showing the channels already registered in the channel-selection channel map.

Here, the channel represented by numerals “19-2” is displayed in such a manner that it is enclosed by a bold line to indicate that it is possibly chosen as a channel to be deleted from the channel-selection channel map. Using remote control 42, the user can perform a switching operation to choose among those already-registered channels. In addition, using remote control 42, the user can perform an operation to decide the chosen, already-registered channel as a channel to be deleted from the channel-selection channel map.

Returning to FIG. 8, at step S125, control unit 10 determines whether or not a signal to decide a choice of any of the already-registered channels is received from remote control reception unit 26. If it is determined that a signal to decide a choice of any of the already-registered channels is not received (if NO at step S125), control unit 10 returns the process to be performed to the caller process of this channel deletion process.

On the other hand, if it is determined that a signal to decide a choice of any of the already-registered channels is received (if YES at step S125), at step S126, control unit 10 deletes the decided, already-registered channel from the channel-selection channel map stored in memory 10B such that it cannot be specified as an already-registered channel. Here, while the channel number of the decided, already-registered channel is left, the already-registered channel cannot be specified as an already-registered channel in the channel-selection channel map. Thereafter, control unit 10 returns the process to be performed to the caller process of this channel deletion process.

On the other hand, if the process proceeds to step S134 at step S122, control unit 10 causes monitor 40 to display information indicating the already-registered channel in the EPG channel map stored in memory 10B.

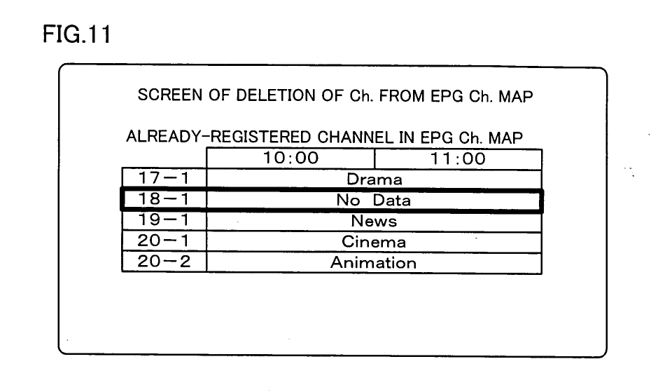

Referring to FIG. 11, the screen of deletion of channel from EPG channel map includes: characters “screen of deletion of Ch. from EPG Ch. Map” that is the designation of this screen; characters “already-registered channel in EPG Ch. Map” that is the designation of the list of the channels already registered in the EPG channel map; and numerals and characters “17-1 Drama”, “18-1 No Data”, “19-1 News”, “20-1 Cinema”, “20-2 Animation” in the list including information indicating the already-registered channels and information indicating the types of the programs shown in EPG on those channels for a prescribed time (here, two hours) from the present time. It is note that “No Data” indicates that EPG for that channel does not exist.

Here, the channel represented by numerals and characters “18-1 No Data” is displayed in such a manner that it is enclosed by a bold line to indicate that it is possibly chosen as a channel to be deleted from the EPG channel map. Using remote control 42, the user can perform a switching operation to choose among those already-registered channels. In addition, using remote control 42, the user can perform an operation to decide the chosen, already-registered channel as a channel to be deleted from the EPG channel map.

Returning to FIG. 8, at step S135, control unit 10 determines whether or not a signal to decide a choice of any of the already-registered channels is received from remote control reception unit 26. If it is determined that a signal to decide a choice of any of the already-registered channels is not received (if NO at step S135), control unit 10 returns the process to be performed to the caller process of this channel addition process.

On the other hand, if it is determined that a signal to decide a choice of any of the already-registered channels is received (if YES at step S135), at step S136, control unit 10 deletes the decided, already-registered channel from the EPG channel map stored in memory 10B such that is cannot be specified as an already-registered channel. Here, while the channel number of the decided, already-registered channel is left, the already-registered channel cannot be specified as an already-registered channel in the EPG channel map. Thereafter, control unit 10 returns the process to be performed to the caller process of this channel deletion process.

For example, in the state of the EPG channel map where the EPG screen in FIG. 7 is displayed, the channel deletion process illustrated in FIG. 8 is performed, so that the already-registered channel desired by the user (here, 18-1) is deleted from the EPG channel map, resulting in the EPG screen shown in FIG. 6.

TABLE 3

| | Registered Channel for | Registered Channel for |
|---|---|---|
| Ch. No. | Channel-Selection | EPG |
| 17-1 | already-registered | already-registered |
| 18-1 | unregistered | unregistered |
| 19-1 | already-registered | already-registered |
| 19-2 | unregistered | unregistered |
| 20-1 | already-registered | already-registered |
| 20-2 | already-registered | already-registered |
| 21-1 | unregistered | unregistered |
| 22-1 | unregistered | unregistered |

Table 3 is a third table showing a channel map including a channel-selection channel map and an EPG channel map.

Referring to FIG. 3, this table is created when the channel deletion process illustrated in FIG. 8 is performed so that an already-registered channel desired by the user is deleted from the channel-selection channel map and the EPG channel map shown in Table 2.

This channel-selection channel map shows that the channel represented by “19-2” is deleted from the channel-selection channel map in Table 2 such that it cannot be specified as an already-registered channel.

Furthermore, this EPG channel map shows that the channel represented by “18-1” is deleted from the EPG channel map in Table 2 such that it cannot be specified as an already-registered channel.

As described above, in broadcast receiving set 1 in the present embodiment, as illustrated in Table 1, the EPG channel map that can specify a channel allowing display of EPG is stored in memory 10B of control unit 10, and the channel-selection channel map that can specify a channel that can be selected is stored in memory 10B of control unit 10.

In addition, as illustrated at step S102 and step S103, in broadcast receiving set 1, a choice of either the EPG channel map or the channel-selection channel map is received from the user as a channel map to which a channel is to be added.

Furthermore, as illustrated at step S114 and step S115, in broadcast receiving set 1, an obtainable channel for which EPG can be obtained is searched for, and an obtainable channel that cannot be specified as a channel allowing display of EPG in the EPG channel map is extracted from the retrieved obtainable channels.

In addition, when the choice of the EPG channel map is received at step S102, as illustrated at step S116 and step S117, in broadcast receiving set 1, the choice of an obtainable channel desired by the user to be added to the EPG channel map is received from the extracted obtainable channels.

Then, as illustrated at step S118, in broadcast receiving set 1, the received obtainable channel is added to the EPG channel map stored in memory 10B such that it can be specified as a channel allowing display of EPG.

Furthermore, as illustrated at step S104 and step S105, in broadcast receiving set 1, a receivable channel on which a broadcast can be received is searched for, and a channel that cannot be specified as a channel that can be selected in the channel-selection channel map is extracted from the retrieved receivable channels.

Furthermore, when the choice of the channel-selection channel map is received at step S103, as illustrated at step S106 and step S107, in broadcast receiving set 1, the choice of a receivable channel desired by the user to be added to the channel-selection channel map is received, from the extracted receivable channels.

Then, as illustrated at step S108, in broadcast receiving set 1, the received receivable channel is added to the channel-selection channel map such that it can be specified as a channel that can be selected.

In this manner, in broadcast receiving set 1, a channel that allows display of EPG and a channel that can be selected are stored in the EPG channel map and the channel-selection channel map, respectively. An obtainable channel and a receivable channel desired by the user to be added are added to the EPG channel map and the channel-selection channel map, respectively. As a result, it is possible to allow selection of a channel without allowing display of EPG of the channel and to allow display of EPG of a channel without allowing selection of the channel.

Furthermore, as illustrated at step S116, in broadcast receiving set 1, information indicating the extracted obtainable channel is displayed on monitor 40. In addition, as illustrated at step S106, in broadcast receiving set 1, information indicating the extracted receivable channel is displayed on monitor 40.

Then, as illustrated at step S117, in broadcast receiving set 1, the choice of an obtainable channel desired by the user to be added is received from the obtainable channels indicated by the displayed information indicating the obtainable channels. Furthermore, as illustrated at step S107, in broadcast receiving set 1, the choice of a receivable channel desired by the user to be added is received from the receivable channels indicated by the displayed information indicating the receivable channels.

In this manner, the user can readily know the obtainable channel and the receivable channel which may be desired to be added by the user.

Furthermore, as illustrated at step S122 and step S123, in broadcast receiving set 1, the choice of either the EPG channel map or the channel-selection channel map is received from the user as a channel map from which a channel is to be deleted.

In addition, when the choice of the EPG channel map is received at step S122, as illustrated at step S134 and step S135, in broadcast receiving set 1, the choice of an already-registered channel desired by the user to be deleted from the EPG channel map is received, from the already-registered channels that can be specified as channels allowing display of EPG in the EPG channel map.

Then, as illustrated at step S136, in broadcast receiving set 1, the received, already-registered channel is deleted from the EPG channel map such that it cannot be specified as a channel allowing display of EPG.

On the other hand, when the choice of the channel-selection channel map is received at step S123, as illustrated at step S124 and step S125, in broadcast receiving set 1, the choice of an already-registered channel desired by the user to be deleted from the channel-selection channel map is received, from the already-registered channels that can be specified as channels that can be selected in the channel-selection channel map.

Then, as illustrated at step S126, in broadcast receiving set 1, the received, already-registered channel is deleted from the channel-selection channel map such that it cannot be specified as a channel that can be selected.

In this manner, in broadcast receiving set 1, a channel that allows display of EPG and a channel that can be selected are stored in the EPG channel map and the channel-selection channel map, respectively. The already-registered channel desired by the user to be deleted is deleted from each of the EPG channel map and the channel-selection channel map. As a result, it is possible to allow selection of a channel without allowing display of EPG of the channel and to allow display of EPG of a channel without allowing selection of the channel.

Furthermore, as described at step S134, in broadcast receiving set 1, the already-registered channel information is displayed on monitor 40 which indicates an already-registered channel that can be specified in the EPG channel map. In addition, as illustrated at step S124, in broadcast receiving set 1, the already-registered channel information is displayed on monitor 40 which indicates an already-registered channel that can be specified in the channel-selection channel map.

Then, as illustrated at step S135 and step S125, in broadcast receiving set 1, the choice of the already-registered channel desired by the user to be deleted is received from the already-registered channels indicated by the displayed, already-registered channel information.

In this manner, the user can readily know the already-registered channel in the EPG channel map and the channel-selection channel map, which may be desired to be deleted by the user.

Additionally, as illustrated in Table 1, in broadcast receiving set 1, an EPG channel map that can specify that EPG of a channel that can specified by a channel number is displayed and a channel-selection channel map that can specify that a channel that can be specified by a channel number may be selected are stored as one channel map in association with a channel number that can specify a channel.

In this manner, a channel number does not have to be redundantly stored in the EPG channel map and the channel-selection channel map. As a result, the storage capacity of memory 10B of control unit 10 for storing a channel map can be reduced.

It is noted that in the present embodiment, EPG data is received together with a broadcast signal received via radio waves. However, the present invention is not limited thereto. Broadcast receiving set 1 may be provided with a communication unit for connecting to the Internet so that EPG data may be received from the Internet.

Furthermore, in the present embodiment, a channel number indicating a channel that was registered before but is not presently registered in the channel-selection channel map or the EPG channel map is left in the channel map. However, a channel number of a channel that is not registered in either the channel-selection channel map or the EPG channel map may be deleted from the channel map. Accordingly, the storage capacity of memory 10B for storing a channel map can be further reduced.

Additionally, in the channel addition process and the channel deletion process as described above with reference to FIG. 2 and FIG. 8, respectively, the order of the steps may be rearranged as long as inconvenience is not caused in the following step.

Furthermore, in the present embodiment, the present invention has been illustrated as broadcast receiving set 1. However, the present invention is not limited thereto and can be understood as a broadcast receiver device having a configuration of broadcast receiving set 1 excluding monitor 40. Alternatively, the present invention can be understood as a recorder device including the broadcast receiver device.

Furthermore, the present invention can be understood as a channel addition control method and a channel deletion control method of performing the channel addition process and the channel deletion process illustrated in FIG. 2 and FIG. 8, respectively, in broadcast receiving set 1, a broadcast receiver device, or a recorder device.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A broadcast receiving set comprising:
channel map storing means for storing, in association with channel identification information that can specify a channel, an electronic program guide channel map that can specify that an electronic program guide of a channel that can be specified by said channel identification information is displayed and a channel-selection channel map that can specify that a channel that can be specified by said channel identification information can be selected, as one channel map;
addition choice reception means for receiving from the user a choice of either the electronic program guide channel map or the channel-selection channel map stored in said channel map storing means, as a channel map to which a channel is to be added;
obtainable channel extraction means for searching for an obtainable channel for which said electronic program guide can be obtained, to extract said obtainable channel that cannot be specified as an electronic program guide display channel in said electronic program guide channel map stored in said channel map storing means, from retrieved said obtainable channel;
obtainable channel display signal output means for outputting a signal to display obtainable channel information indicating said obtainable channel extracted by said obtainable channel extraction means;
obtainable channel reception means for receiving a choice of said obtainable channel desired by a user to be added to said electronic program guide channel map from said obtainable channel indicated by said obtainable channel information displayed in response to the signal output by said obtainable channel display signal output means, when a choice of said electronic program guide channel map is received by said addition choice reception means;
obtainable channel addition means for adding said obtainable channel received by said obtainable channel reception means to said electronic program guide channel map stored in said channel map storing means such that said obtainable channel can be specified as said electronic program guide display channel;
receivable channel extraction means for searching for a receivable channel on which a broadcast can be received, to extract said receivable channel that cannot be specified as a selectable channel in said channel-selection channel map stored in said channel map storing means, from retrieved said receivable channel;
receivable channel display signal output means for outputting a signal to display receivable channel information indicating said receivable channel extracted by said receivable channel extraction means;
receivable channel reception means for receiving a choice of said receivable channel desired by a user to be added to said channel-selection channel map from said receivable channel indicated by said receivable channel information displayed in response to the signal output by said receivable channel display signal output means, when a choice of said channel-selection channel map is received by said addition choice reception means;
receivable channel addition means for adding said receivable channel received by said receivable channel reception means to said channel-selection channel map stored in said channel map storing means such that said receivable channel can be specified as said selectable channel;
deletion choice reception means for receiving a choice of either the electronic program guide channel map or the channel-selection channel map stored in said channel map storing means, as a channel map from which a channel is to be deleted;
electronic program guide already-registered channel display signal output means for outputting a signal to display electronic program guide already-registered channel information indicating an already-registered channel for electronic program guide that can be specified in said electronic program guide channel map stored in said channel map storing means;
electronic program guide already-registered channel reception means for receiving a choice of said already-registered channel for electronic program guide desired by a user to be deleted from said electronic program guide channel map from said already-registered channel for electronic program guide indicated by said electronic program guide already-registered channel information displayed in response to the signal output by said electronic program guide already-registered channel display signal output means, when a choice of said electronic program guide channel map is received by said deletion choice reception means;
electronic program guide already-registered channel deletion means for deleting said already-registered channel for electronic program guide received by said electronic program guide already-registered channel reception means from said electronic program guide channel map stored in said channel map storing means such that said already-registered channel for electronic program guide cannot be specified as said electronic program guide display channel;
channel-selection already-registered channel display signal output means for outputting a signal to display channel-selection already-registered channel information indicating an already-registered channel for channel-selection that can be specified in said channel-selection channel map stored in said channel map storing means;
channel-selection already-registered channel reception means for receiving a choice of said already-registered channel for channel-selection desired by a user to be deleted from said channel-selection channel map from said already-registered channel for channel-selection indicated by said channel-selection already-registered channel information displayed in response to the signal output by said channel-selection already-registered channel display signal output means, when a choice of said channel-selection channel map is received by said deletion choice reception means;
channel-selection already-registered channel deletion means for deleting said already-registered channel for channel-selection received by said channel-selection already-registered channel reception means from said channel-selection channel map stored in said channel map storing means such that said already-registered channel for channel-selection cannot be specified as said selectable channel; and
display means for displaying said obtainable channel information, said receivable channel information, said electronic program guide already-registered channel information, or said channel-selection already-registered channel information indicated by a signal output by said obtainable channel display signal output means, said receivable channel display signal output means, said electronic program guide already-registered channel display signal output means, or said channel-selection already-registered channel display signal output means, respectively.

2. A broadcast receiver device comprising:
electronic program guide channel map storing means for storing an electronic program guide channel map that can specify an electronic program guide display channel allowing display of an electronic program guide;
channel-selection channel map storing means for storing a channel-selection channel map that can specify a selectable channel that can be selected;
choice reception means for receiving from a user a choice of either the electronic program guide channel map stored in said electronic program guide channel map storing means or the channel-selection channel map stored in said channel-selection channel map storing means, as a channel map to which a channel is to be added;
obtainable channel extraction means for searching for an obtainable channel for which said electronic program guide can be obtained, to extract said obtainable channel that cannot be specified as an electronic program guide display channel in said electronic program guide channel map stored in said electronic program guide channel map storing means, from retrieved said obtainable channel;
obtainable channel reception means for receiving a choice of said obtainable channel desired by a user to be added to said electronic program guide channel map from said obtainable channel extracted by said obtainable channel extraction means, when a choice of said electronic program guide channel map is received by said choice reception means;
obtainable channel addition means for adding said obtainable channel received by said obtainable channel reception means to said electronic program guide channel map stored in said electronic program guide channel map storing means such that said obtainable channel can be specified as said electronic program guide display channel;
receivable channel extraction means for searching for a receivable channel on which a broadcast can be received, to extract said receivable channel that cannot be specified as said selectable channel in said channel-selection channel map stored in said channel-selection channel map storing means, from retrieved said receivable channel;
receivable channel reception means for receiving a choice of said receivable channel desired by a user to be added to said channel-selection channel map from said receivable channel extracted by said receivable channel extraction means, when a choice of said channel-selection channel map is received by said choice reception means; and
receivable channel addition means for adding said receivable channel received by said receivable channel reception means to said channel-selection channel map stored in said channel-selection channel map storing means such that said receivable channel can be specified as said selectable channel.

3. The broadcast receiver device according to claim 2, further comprising:
obtainable channel display signal output means for outputting a signal to display obtainable channel information indicating said obtainable channel extracted by said obtainable channel extraction means; and
receivable channel display signal output means for outputting a signal to display receivable channel information indicating said receivable channel extracted by said receivable channel extraction means, wherein
said obtainable channel reception means receives a choice of said obtainable channel desired by a user to be added, from said obtainable channel indicated by said obtainable channel information displayed in response to the signal output by said obtainable channel display signal output means, and
said receivable channel reception means receives a choice of said receivable channel desired by a user to be added, from said receivable channel indicated by said receivable channel information displayed in response to the signal output by said receivable channel display signal output means.

4. The broadcast receiver device according to claim 3, wherein said electronic program guide channel map storing means and said channel-selection channel map storing means store, in association with channel identification information that can specify a channel, said electronic program guide channel map that can specify that an electronic program guide of a channel that can be specified by said channel identification information is displayed and said channel-selection channel map that can specify that a channel that can be specified by said channel identification information can be selected, as one channel map.

5. A broadcast receiver device comprising:
electronic program guide channel map storing means for storing an electronic program guide channel map that can specify an electronic program guide display channel allowing display of an electronic program guide;
channel-selection channel map storing means for storing a channel-selection channel map that can specify a selectable channel that can be selected;
choice reception means for receiving from a user a choice of either the electronic program guide channel map stored in said electronic program guide channel map storing means or the channel-selection channel map stored in said channel-selection channel map storing means, as a channel map from which a channel is to be deleted;
electronic program guide already-registered channel reception means for receiving a choice of an already-registered channel for electronic program guide desired by a user to be deleted from said electronic program guide channel map from said already-registered channel for electronic program guide that can be specified as an electronic program guide display channel in said electronic program guide channel map stored in said electronic program guide channel map storing means, when a choice of said electronic program guide channel map is received by said choice reception means;
electronic program guide already-registered channel deletion means for deleting said already-registered channel for electronic program guide received by said electronic program guide already-registered channel reception means from said electronic program guide channel map stored in said electronic program guide channel map storing means such that said already-registered channel for electronic program guide cannot be specified as said electronic program guide display channel;
channel-selection already-registered channel reception means for receiving a choice of an already-registered channel for channel-selection desired by a user to be deleted from said channel-selection channel map from said already-registered channel for channel-selection that can be specified as a selectable channel in said channel-selection channel map stored in said channel-selection channel map storing means, when a choice of said channel-selection channel map is received by said choice reception means; and
channel-selection already-registered channel deletion means for deleting said already-registered channel for channel-selection received by said channel-selection already-registered channel reception means from said channel-selection channel map stored in said channel-selection channel map storing means such that said already-registered channel for channel-selection cannot be specified as said selectable channel.

6. The broadcast receiver device according to claim 5, further comprising:
electronic program guide already-registered channel display signal output means for outputting a signal to display electronic program guide already-registered channel information indicating said already-registered channel for electronic program guide that can be specified in said electronic program guide channel map stored in said electronic program guide channel map storing means; and
channel-selection already-registered channel display signal output means for outputting a signal to display channel-selection already-registered channel information indicating said already-registered channel for channel-selection that can be specified in said channel-selection channel map stored in said channel-selection channel map storing means, wherein
said electronic program guide already-registered channel reception means receives a choice of said already-registered channel for electronic program guide desired by a user to be deleted from said already-registered channel for electronic program guide indicated by said electronic program guide already-registered channel information displayed in response to the signal output by said electronic program guide already-registered channel display signal output means, and
said channel-selection already-registered channel reception means receives a choice of said already-registered channel for channel-selection desired by a user to be deleted from said already-registered channel for channel-selection indicated by said channel-selection already-registered channel information displayed in response to the signal output by said channel-selection already-registered channel display signal output means.

7. The broadcast receiver device according to claim 6, wherein said electronic program guide channel map storing means and said channel-selection channel map storing means store, in association with channel identification information that can specify a channel, said electronic program guide channel map that can specify that an electronic program guide of a channel that can be specified by said channel identification information is displayed, and said channel-selection channel map that can specify that a channel that can be specified by said channel identification information can be selected, as one channel map.

8. A broadcast receiving set comprising the broadcast receiver device according to claim 2 and display means for displaying information indicated by a signal output from said broadcast receiver device.

9. A broadcast receiving set comprising the broadcast receiver device according to claim 5 and display means for displaying information indicated by a signal output from said broadcast receiver device.

10. A channel addition control method performed by a broadcast receiver device including storage means for storing prescribed information, wherein said storage means stores an electronic program guide channel map that can specify an electronic program guide display channel allowing display of an electronic program guide and a channel-selection channel map that can specify a selectable channel that can be selected, said method comprising the steps of:
receiving from a user a choice of either said electronic program guide channel map or said channel-selection channel map stored in said storage means, as a channel map to which a channel is to be added;
searching for an obtainable channel for which said electronic program guide can be obtained, to extract said obtainable channel that cannot be specified as an electronic program guide display channel in said electronic program guide channel map stored in said storage means, from retrieved said obtainable channel;
receiving a choice of said obtainable channel desired by a user to be added to said electronic program guide channel map from extracted said obtainable channel, when a choice of said electronic program guide channel map is received;
adding received said obtainable channel to said electronic program guide channel map stored in said storage means such that said obtainable channel can be specified as said electronic program guide display channel;
searching for a receivable channel on which a broadcast can be received, to extract said receivable channel that cannot be specified as said selectable channel in said channel-selection channel map stored in said storage means, from retrieved said receivable channel;
receiving a choice of said receivable channel desired by a user to be added to said channel-selection channel map from extracted said receivable channel, when a choice of said channel-selection channel map is received; and
adding received said receivable channel to said channel-selection channel map stored in said storage means such that said receivable channel can be specified as said selectable channel.

11. A channel deletion control method performed by a broadcast receiver device including storage means for storing prescribed information, wherein said storage means stores an electronic program guide channel map that can specify an electronic program guide display channel allowing display of an electronic program guide and a channel-selection channel map that can specify a selectable channel that can be selected, said method comprising the steps of:
receiving from a user a choice of either said electronic program guide channel map or said channel-selection channel map stored in said storage means, as a channel map from which a channel is to be deleted;
receiving a choice of an already-registered channel for electronic program guide desired by a user to be deleted from said electronic program guide channel map from said already-registered channel for electronic program guide that can be specified as an electronic program guide display channel in said electronic program guide channel map stored in said storage means, when a choice of said electronic program guide channel map is received;
deleting received said already-registered channel for electronic program guide from said electronic program guide channel map stored in said storage means such that said already-registered channel for electronic program guide cannot be specified as said electronic program guide display channel;
receiving a choice of an already-registered channel for channel-selection desired by a user to be deleted from said channel-selection channel map from said already-registered channel for channel-selection that can be specified as a selectable channel in said channel-selection channel map stored in said storage means, when a choice of said channel-selection channel map is received; and
deleting received said already-registered channel for channel-selection from said channel-selection channel map stored in said storage means such that said already-registered channel for channel-selection cannot be specified as said selectable channel.
